(19) United States
(12) Patent Application Publication
(10) Pub. No.: US 2018/0248797 A1
(43) Pub. Date: Aug. 30, 2018

(54) METHOD AND SYSTEM OF PROTECTION IN TIME SENSITIVE NETWORKS OF A RING TOPOLOGY OF RING TOPOLOGY

(71) Applicants: ACTUSNETWORKS Co., LTD., Anyang-si (KR); Industry-Academia Cooperation Group Of Sejong University, Seoul (KR)

(72) Inventors: Ajung KIM, Seoul (KR); Kwangho CHO, Anyang-si (KR); Su sang YOO, Anyang-si (KR); Eun hong PARK, Anyang-si (KR)

(21) Appl. No.: 15/444,472

(22) Filed: Feb. 28, 2017

(51) Int. Cl. H04L 12/721; H04L 12/42; H04L 12/26; H04L 12/863

(52) U.S. Cl. CPC H04L 45/70; H04L 12/42; H04L 45/66; H04L 47/50; H04L 43/0858

(57) ABSTRACT

A protection switching method in a time sensitive network of a ring topology consisting of layer 2 switch-based nodes includes ranging to measure a first delay until a packet arrives at each node, RT, after transmitted by the main node OT via a path of a first direction and a second delay via a path of a second direction, performing a transmission delay compensation in the first direction or in the second direction based on the first and second delays, transmitting data to one direction of the first direction and the second direction based on the delay compensation, and performing a protection switching and compensating by performing the protection switching and compensation based on the measured delay after the switchover.

### BACKGROUND

Embodiments of the inventive concepts described herein relate to a protection switching method and system for a fronthaul network of a ring topology, and more particularly, relate to a technology to reduce a time delay variation when protection switching occurs.

In recent years, as the number of cells in a mobile communication increases, the Baseband Unit (BBU) (in case of 4G, and Data Unit in case of 3G) and the Remote Radio Head (RRH) (in case of 4G, and Radio unit in case of 3G), which are integrated in a conventional base station, are separated to form Cloud-Radio Access Network (C-RAN).

FIG. 1 is a diagram showing an architecture of C-RAN.

Referring to FIG. 1, C-RAN includes BBU (in case of 4G, and DU in case of 3G) and RRH (in case of 4G, and RU in case of 3G). In FIG. 1, the BBU is a baseband processing device of a conventional base station, and the RRH is a RF antenna unit of a conventional base station. A fronthaul network is formed between the BBU and the RRH.

The C-RAN is a network architecture for a wireless/mobile transmission, in which the conventional base station is separated into the baseband processing unit BBU and the RF antenna unit RRH in a manner that the BBUs of a plurality of base stations are centralized in a BBU pool and the RRHs are distributed in each service cell. Since the BBUs are centralized in a cloud data center, it is easy to operate and maintain and the cooperative communication networks are possible. C-RAN with the centralized BBUs has attracted attentions in that it can reduce cost for power supply, rental space, and network maintenance. The BBU is connected to the RRH via an optical cable using interfaces such as Common Public Radio Interface CPRI, Open Radio Equipment Interface ORI, Open Base Station Architecture Initiative OBSAI, etc.

In attempts to establish networks in a fronthaul span, nodes based on a layer 2 switch, e.g. Ethernet switch are employed for flexible and cost effective solutions. However, a protection switching protocol has not yet regulated in associated with the fronthaul network. While ITU-T G.8032 ring protection switching protocol is available for a ring topology configured by the L2 switch based nodes, a ring protection switching appropriate for a time sensitive network is not devised yet. In the mobile telecommunication where managing timing parameters is critical, a steady delay with reduced delay variation is required even in the case of network reconfiguration. For instance, in time sensitive networks of a ring topology, transmission lengths between west/east (clockwise/counter-clockwise) directions are different, which results in a huge delay variation when protection switching occurs and requires a protection switching technology producing less delay variation for the fronthaul network. The delay variation may be reduced by managing a buffer or dynamically controlling a buffer size.

### SUMMARY

Embodiments of the inventive concepts provide a protection switching method and system for a time sensitive network consisting of a plurality of nodes based on a layer-2 switch in a ring topology, which performs compensating for a delay measured through a ranging operation and manages a size of buffer so that the delay variation is reduced even when the protection switching occurs.

One aspect of embodiments of the inventive concept is directed to a protection switching method in a time sensitive network with a ring topology consisting of a plurality of switch-based nodes, including ranging to measure a first delay until a packet arrives at each node connected to RRHs, RT, after transmitted by the main node connected to a BBU (owner node (OT) in case of ITU-T G.8032) via a path of a first direction and a second delay via a path of a second direction, performing a transmission delay compensation in the first direction or in the second direction based on one value of the first delay and the second delay, transmitting data by selecting one direction as the working direction (corresponding direction and delay are respectively referred to as a “before direction” and a “before delay”) and the other direction as the backup direction (corresponding direction and delay are respectively referred to as an “after direction” and an “after delay”) until the protection switching occurs, and performing a protection switching and compensating based on the measured delay after the switchover.

According to an embodiment, a port to the first direction and a port to the second direction of the main node are unblocked in the ranging to measure the first delay and the second delay.

According to an embodiment, transmitting the data includes blocking a port to the backup direction (after direction), and normally transmitting data via the unblocked port to the working direction (before direction).

According to an embodiment, the performing the protection switching and compensating includes broadcasting, by nodes adjacent to failure line, a signal failure message, unblocking the blocked port, by the main node, and transmitting data and ranging messages to both directions, and performing, by each RT node, compensating based on the delay measured after the switching.

According to an embodiment, the compensating for the delay with respect to the reference delay includes adjusting a size of a buffer based on the measured first delay and the measured second delay.

According to an embodiment, the performing the delay compensation includes determining a reference delay based on the first delay and the second delay and compensating for a delay so that the transmission delay should become equal to the determined reference delay.

According to an embodiment, the determining the reference delay includes choosing the larger delay between the first delay and the second delay as the reference delay.

According to an embodiment, the compensating for the delay so that the transmission delay should become equal to the determined reference delay includes increasing, in a case that the data are transmitted in a direction producing the smaller delay between in the first direction and in the second direction, the size of the buffer by adding a value corresponding to a difference between the first delay and the second delay to a default buffer size in order to make the data transmission delay maintained equal to the reference delay (Db=D). In addition, in a case that the data transmission direction is a direction producing the larger delay between in the first direction and in the second direction, the delay compensation for data transmission is omitted (Db=D) and the size of the buffer is maintained as the default value.

According to an embodiment, the performing the operation corresponding to the protection switching by the each RT node includes comparing the before delay measured before the protection switching to the after delay measured after the protection switching and increasing or decreasing the current size of a buffer by a value corresponding to a difference in delays between before and after switching based on the result of the comparing process in the case that the delay is changed due to the switching.

Another aspect of embodiments of the inventive concept is directed to provide a protection switching system in a time sensitive network consisting of a plurality of switch-based nodes with a ring topology, including a ranging unit to measure a first delay until a packet arrives at each node RT, after transmitted by the main node connected to a BBU (owner node (OT) in case of ITU-T G.8032) via a path of a first direction and a second delay via a path of a second direction, a compensating unit performing a transmission delay compensation in the first direction or in the second direction based on one value of the first delay and the second delay, a transmitting unit selecting one direction as the working direction (corresponding direction and delay are respectively referred to as a “before direction” and a “before delay”) and the other direction as the backup direction (corresponding direction and delay are respectively referred to as an “after direction” and an “after delay”) until the protection switching occurs, and performing a protection switching and compensating based on the measured delay after the switchover.

According to an embodiment, the ranging unit unblocks a port to the first direction and a port to the second direction of the main node to measure the first delay and the second delay.

According to an embodiment, the transmitting unit blocks a port to the backup direction (after direction), and normally transmit data via the unblocked port to the working direction (before direction).

According to an embodiment, the protection switching/compensating unit broadcasts, by a node adjacent to failure line, a signal failure message, unblocks the blocked port, by the main node, and transmits data and ranging messages to both directions, and performs, by each RT node, compensating based on the delay measured after the switching.

According to an embodiment, the compensating unit adjusts a size of a buffer based on the measured first delay and the measured second delay.

According to an embodiment, the compensating unit determines a reference delay based on the first delay and the second delay and compensates for a delay so that the transmission delay should become equal to the determined reference delay.

According to an embodiment, the larger delay between the first delay and the second delay is determined as the reference delay.

According to an embodiment, the compensating for the delay so that the transmission delay should become equal to the determined reference delay includes increasing, in a case that the data are transmitted in a direction producing the smaller delay between in the first direction and in the second direction, the size of the buffer by adding a value corresponding to a difference between the first delay and the second delay to a default buffer size in order to make the data transmission delay maintained equal to the reference delay. In addition, in a case that the data transmission direction is a direction producing the larger delay between in the first direction and in the second direction, the delay compensation for data transmission is omitted and the size of the buffer is maintained as the default value.

According to an embodiment, the performing the operation corresponding to the protection switching and compensating by the each RT node is performed by comparing the before delay measured before the protection switching to the after delay measured after the protection switching and increasing or decreasing the current size of a buffer by a value corresponding to a difference in delays between before and after switching based on the result of the comparing process in the case that the delay is changed due to the switching.

According to the above, in the fronthaul network consisting of a plurality of switch-based nodes with a ring topology, the buffer is managed to compensate for the delay, and thus the delay variation caused by the transmission length difference between the two directions may be reduced even in the protection switching, which achieves the stable transition of the network and improves the performance of the time sensitive network such as the fronthaul network.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic diagram showing a configuration of a C-RAN;

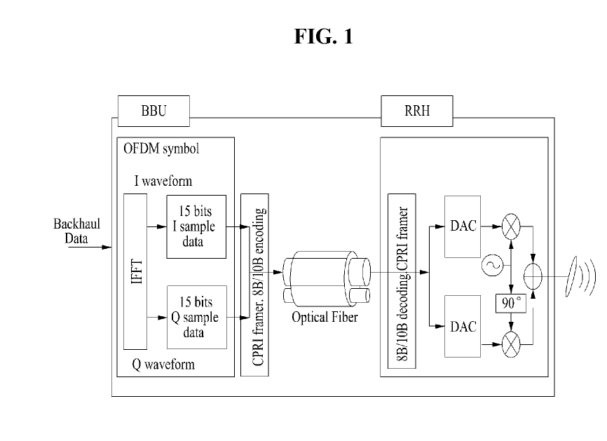

FIG. 2 is a schematic diagram showing a fronthaul network with a ring topology according to an exemplary embodiment of the present inventive concept;

FIG. 3 is a flowchart showing operations of performing ranging, setting, and protection switching according to an exemplary embodiment of the present inventive concept;

FIG. 4 is a block diagram showing a detailed configuration of a protection switching system of each node according to an exemplary embodiment of the present inventive concept;

FIG. 5 is a flowchart showing a protection switching and compensating method when a switching occurs according to an exemplary embodiment of the present inventive concept;

FIG. 6 is a schematic diagram showing a network with a ring topology to explain ranging and compensating processes according to an exemplary embodiment of the present inventive concept; and

FIG. 7 is a schematic diagram showing a network with a ring topology in which a switching occurs according to an exemplary embodiment of the present inventive concept.

FIG. 8 is a schematic diagram showing an embodiment in which the ranging operation is implemented.

### DETAILED DESCRIPTION

Hereinafter, embodiments according to the present inventive concept will be described in detail with reference to accompanying drawings.

A fronthaul network is a network formed by an architecture in which a conventional base station is divided into a baseband unit (BBU) that serves as a baseband signal processing unit and a remote radio head (RRH) that serves as an antenna unit, and the present inventive concept relates to technologies for a protection switching and delay variation reduction in a fronthaul network of a ring topology implemented in nodes based on a layer-2 switch. In more detail, the present inventive concept relates to a mobile communication or a fronthaul network, which is based on protection switching technology having a ring topology and a working and a backup paths in the clockwise and the counterclockwise directions, such as in ITU-TG.8032, and more particularly, relates to a stable data transmission technology achieved by performing a ranging operation measuring a transmission distance (Le., a delay time), performing a delay compensation/equalization operation to reduce a delay variation due to a length difference between the paths in the clockwise and counterclockwise directions, and managing a buffer based on the delay compensation/equalization.

In embodiments, the term “node” used herein indicates switch-based nodes forming the fronthaul network with the ring topology, and corresponds to a main node OT connected to a BBU/BBU pool or an RT connected to one or more RRHs. In addition, the main node may correspond to a node that switches a data transmission direction when the protection switching occurs in the fronthaul network with the ring topology in accordance with a protection switching protocol, such as G.8032.

In embodiments, the term “first direction” used herein may indicate a counterclockwise direction for transmitting data to the nodes in the fronthaul network with the ring topology, and the term “second direction” used herein may indicate a clockwise direction.

In embodiments, a protection switching performed in the fronthaul network will be described as a representative example, however it should not be limited thereto or thereby. That is, the protection switching method and the system may be applied to all networks, e.g., a time sensitive network, a flexible communication network, etc., requiring a dynamic protection switching in addition to the fronthaul network.

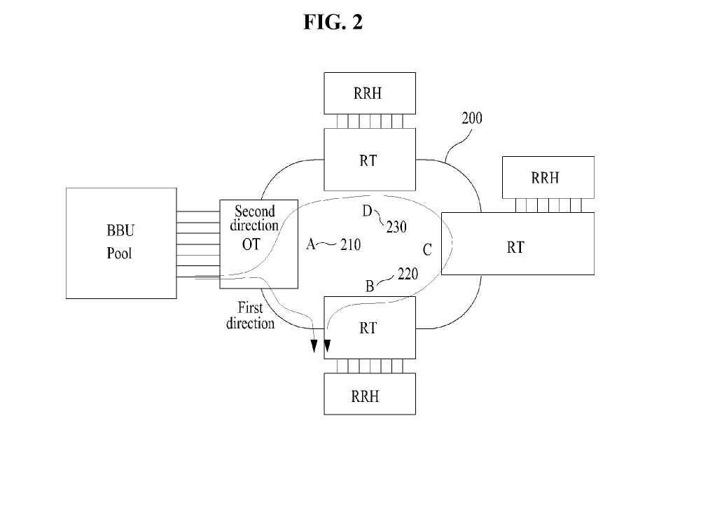

FIG. 2 is a schematic diagram showing a fronthaul network with a ring topology according to an exemplary embodiment of the present inventive concept.

FIG. 2 shows the BBU pool, the OT, the RT, and the RRH, and the fronthaul network 200 with the ring topology.

The BBU may process the baseband signal,. In addition, clocks used for synchronization and data transmission/reception may exist in the BBU, the RRH, and each node.

The OT may be connected to the BBU/BBU pool and connected to a plurality of RTs in a ring topology,. The RT may be connected to the RRH and connected to the OT and other RTs in a ring topology.

In the fronthaul network, a signal transmission from the BBU to the RRH via the node OT and RT will be referred to as a “downlink”, and a transmission from the RRH to the BBU via the node RT and OT will be referred to as an “uplink”. An OT A 210 of the main node may block one of input/output ports connected to an RT B 220 or an RT D 230 to determine the transmission direction of the downlink. In embodiments, in a case that the OT A 210 blocks the port connected to the RT D 230, the transmission direction of the downlink becomes the counterclockwise direction corresponding to the first direction, and the transmission direction of the uplink becomes the clockwise direction corresponding to the second direction. When the OT A 210 blocks the port connected to the RT B 220, the transmission direction of the downlink becomes the counterclockwise direction, and the transmission direction of the uplink becomes the clockwise direction.

Focusing on the downlink transmission, in a case that the data are transmitted from the OT A 210 to the RT B 220, a difference in transmission delay occurs between the clockwise direction and the counterclockwise direction. For instance, if the transmission delay D1 from the OT 210 to the RT B 220 in the first direction is about 5 microseconds (μsec) and the transmission delay D2 in the second direction via the RT D and the RT C is about 15 μsec, the transmission delay difference DD becomes 10 μsec. The delay variation is required to be reduced since the delay variation may cause hand-over problems in an overlapped region among cells in the time sensitive network like the mobile communication. The delay variation may be managed with using a buffer, and thus the delay variation may be reduced by dynamically controlling a size of the buffer.

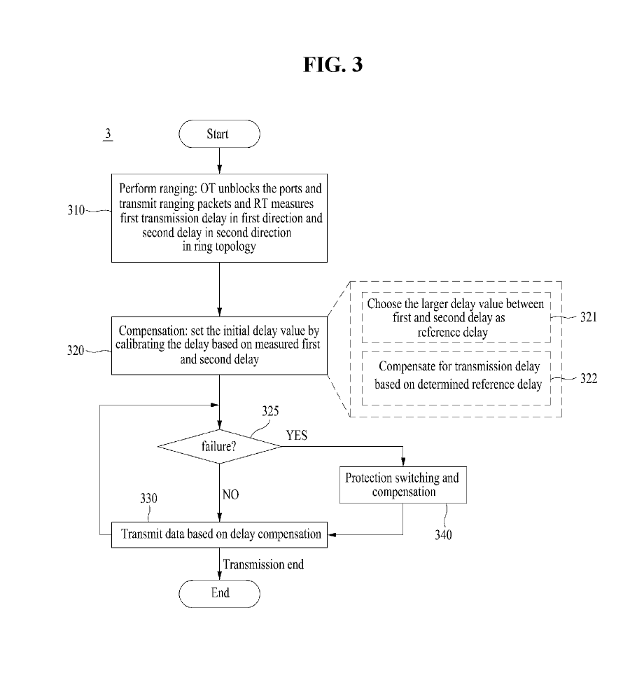

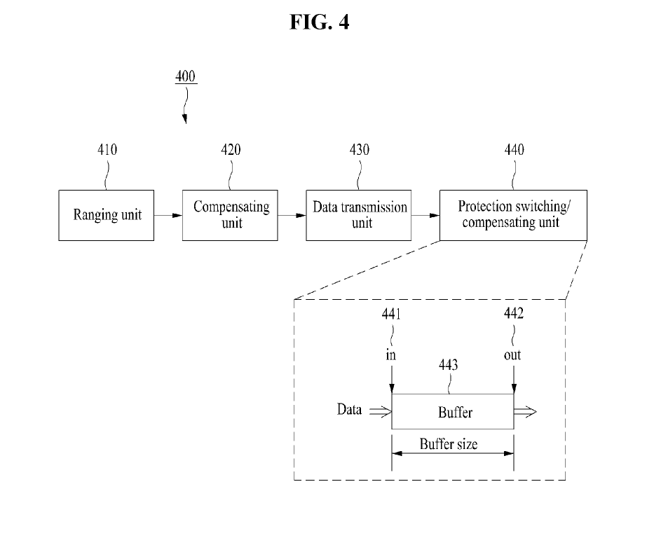

FIG. 3 is a flowchart showing operations of performing ranging, setting, and protection switching according to an exemplary embodiment of the present inventive concept, and FIG. 4 is a block diagram showing an detailed configuration of a protection switching system of each node according to an exemplary embodiment of the present inventive concept.

Referring to FIG. 4, each node 400 may include a ranging unit 410, a compensating unit 420, a transmitting unit 430, and a protection switching/compensating unit 440. The protection switching/compensating unit 440 may include a buffer 443 that performs a compensation operation.

As shown in FIG. 4, the protection switching/compensating unit 440 may include a buffer having a sliding window for the delay compensation, and the delay may be controlled by adjusting a size of the sliding window of the buffer. In an embodiment of the present inventive concept, a first-in-first-out (FIFO) buffer may be used as the buffer 443, and in this case, the size of the buffer may increase or decrease by moving an in-pointer 441 and an out-pointer 442 since the size of the buffer is determined by positions of the in-pointer 441 and the out-pointer 442 of the sliding window. When the size of the buffer increases, a time interval between an input and an output of the buffer increases, and thus the delay may be compensated for by adjusting the buffer size.

Operations 310 to 340 shown in FIG. 3 may be performed by the ranging unit 410, the compensating unit 420, the transmitting unit 430, and the protection switching/compensating unit 440 shown in FIG. 4.

In operation 310, in the case of the main node, the ranging unit 410 of the main node may unblock the input/output port in both directions, i.e., the first direction and the second direction, to transmit ranging packet for the ranging operation to the nodes that form the ring topology in the fronthaul network.

Here, the both directions may be the data transmission direction of the downlink, and the both directions may indicate the clockwise direction and the counterclockwise direction to transmit the data to the nodes connected to the main node in the ring topology.

In operation 310, in the case of an RT node, the ranging unit 410 of the RT node may measure a first delay D1 until the ranging packet arrives at the RT after transmitted by the main node OT via a path of the first direction (i.e., the counterclockwise direction). In addition, the ranging unit 410 of the RT node may measure a second delay D2 that the ranging packet arrives at the RT after transmitted by the main node OT via a path of the second direction (i.e., the clockwise direction).

For instance, the ranging unit 410 of the RT node may measure the delay with the received ranging packet containing time stamp issued by the OT.

In operation 320, the compensating unit 420 of the RT may perform a data transmission delay compensation based on the first delay and the second delay values.

In operation 321, the compensating unit 420 of the RT may choose the larger delay value between the first delay and the second delay as a reference delay value D.

As an example, in the case that the first delay D1 is measured of about 5 microseconds (μsec) and the second delay D2 is measured of about 15 microseconds (μsec), when the protection switchover occurs, the delay variation of |D1−D2|=10 μsec may occur due to the difference between transmission delays in the first and in the second direction, Accordingly, the compensating unit 420 may determine the larger delay value between the first delay and the second delay as the reference delay D. For the aforementioned exemplary case, the reference delay value may be determined as D=D2=15 μsec.

In operation 322, the compensating unit 420 of the RT may compensate for the transmission delay based on the determined reference delay. That is, the compensating unit 420 may perform the delay compensation in preparation for the data transmission with a blocked port of the OT to either the first direction or the second direction so that the data transmission delay becomes equal to the reference delay value.

For instance, in the case that the data transmission direction is the first direction (in which the delay value is smaller, e.g., D1=5 μsec), the compensating unit 420 of the RT may increase the delay by delay difference DD=|D1−D2|=10 μsec that is the difference between the delays in the first and the second direction, and thus the data transmission delay may be maintained to be the same as the reference delay of D=15 μsec when the switchover in transmission direction occurs. For instance, the compensating unit 420 may include a buffer, and increase the size of the buffer by adding a value corresponding to the delay difference value DD to a default buffer size to make the data transmission delay to be equal to the reference delay value. In addition, in the case that the data transmission direction is the second direction (in which the delay value is larger, e.g., D2=15 μsec), the delay compensation may be omitted since the data transmission delay is equal to the reference delay value and the size of the buffer remains the same as the default value.

In operation 330, the transmitting unit 430 may perform the data transmission based on the delay compensation. The data transmission direction may be set to one of the first direction and the second direction by a blocked port in the OT node. According to protocols regarding layer-2 switches, the main node OT blocks a port to prevent a loop in the ring topology and uses the path through the unblocked port as the working path and direction for data transmission. The other direction is reserved for backup in time for protection switching.

For instance, in a case that the first direction corresponding to the counterclockwise direction is set to the data transmission direction of the downlink and the second direction corresponding to the clockwise direction is set to the backup direction, the main node may block the port to the second direction transmit data via the unblocked port so that data are transported only in the first direction. in the ring topology.

In this case, the data are transferred in the transmission direction, and when switchover of direction occurs, the delay may be maintained the same as the reference delay value by adjusting the compensating value for the delay and thus the delay variation caused by the transmission length difference in between the two directions may be reduced and the stable transition may be achieved.

In operation 325, in the case that the signal failure, for example, transmission failure or line cut-off, occurs (325:YES), the protection switching/compensating unit 440 may perform an protection switching and compensating operation. On the contrary, in the normal case that the signal failure does not occur (325:NO), the transmitting unit 430 may continuously perform the data transmission in the working direction.

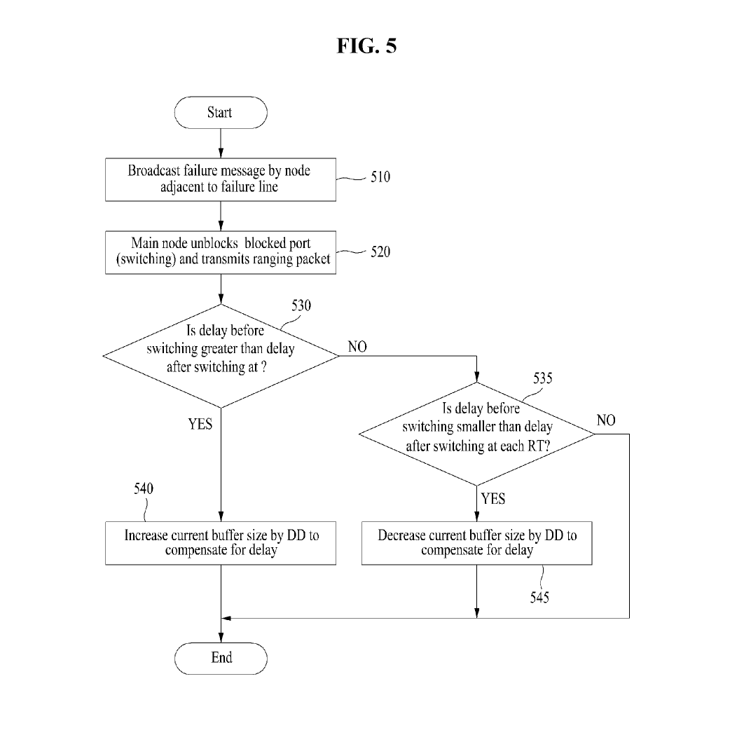

Hereinafter, an protection switching and compensating operation will be described in detail with reference to FIG. 5.

FIG. 5 is a flowchart showing a protection switching and compensating method when the switching occurs according to an exemplary embodiment of the present inventive concept.

Operations 510 to 545 shown in FIG. 5 may correspond to the protection switching/compensating operation 340 shown in FIG. 3 and may be performed by the protection switching/compensating unit 440 shown in FIG. 4 as a component of the node.

When the signal failure occurs, a proximate node adjacent to the failure line may broadcast a signal failure (SF) message, and the main node OT may unblock the blocked port (e.g., a port to the direction corresponding to the backup line), which is a protection switching process.

In operation 510, the proximate node adjacent to the failure line may broadcast the signal failure (SF). In operation 520, the main node OT may receive the SF signal and unblock the blocked port to the backup direction and transmit ranging packets via all unblocked ports. Operations 530 and 540 may correspond to the compensation process at each RT node. Each RT node may compare the actual transmission delay Db without compensation before the switching with the delay Da after the switching occurs. Then each RT node may increase the buffer size by adding the value corresponding to the delay difference DD to a current buffer size if the delay Db is greater than the delay Da (Db>Da), thereby compensating for the delay (540). If the delay Db is smaller than the delay Da (Db<Da), the buffer size may be decreased by subtracting the value corresponding to the delay difference DD from the current buffer size to compensate for the delay (545). In a case that the delay Db has no difference to the delay Da (Db=Da), the compensation process is omitted and the size of the buffer remains unchanged.

The compensation process after protection switching may be performed before normal data transmission or in the middle of normal data transmission to meet the protection switching time requirement.

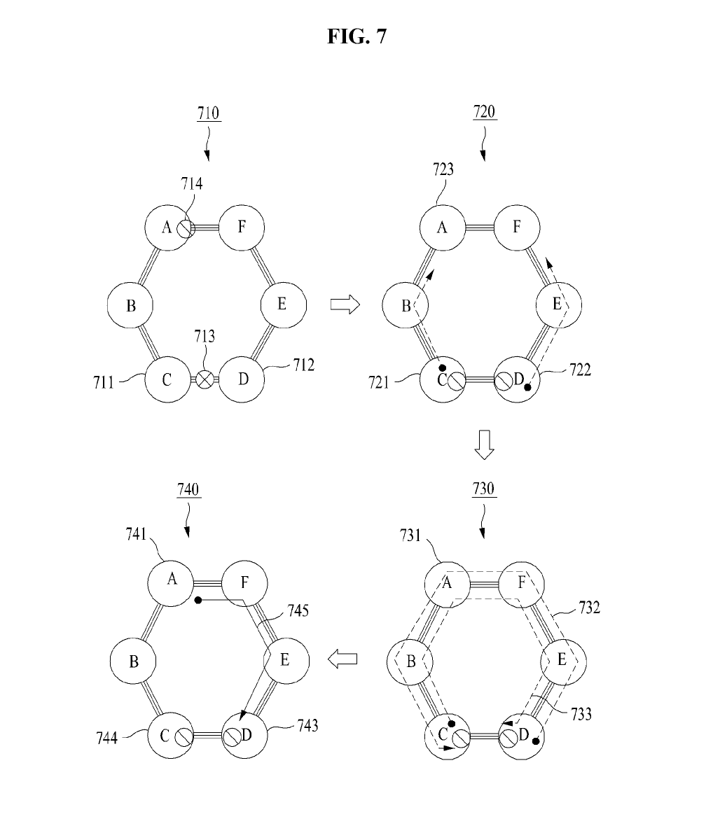

Detailed descriptions on the operation of the protection switching when the switching occurs will be described later with reference to FIG. 7.

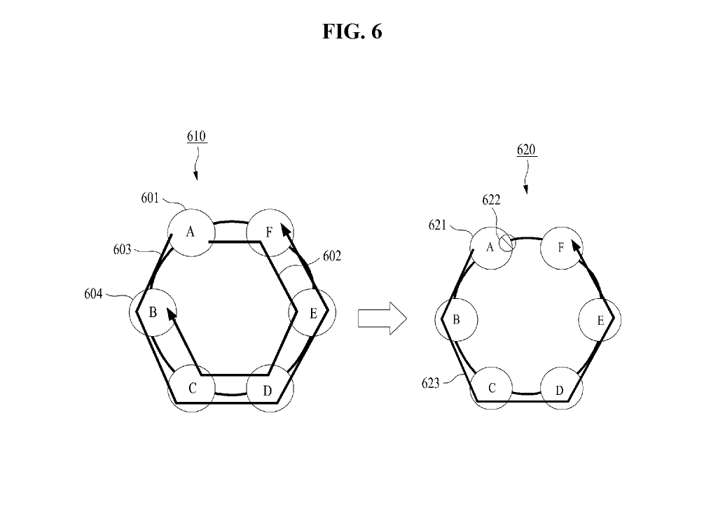

FIG. 6 is a schematic diagram showing a network with a ring topology to explain ranging and data transmission processes according to an exemplary embodiment of the present inventive concept.

Referring to 610 of FIG. 6, a main node A 601 may unblock each port in ring topology for the ranging operation. In addition, a ranging packet may be transmitted to each of the nodes connected in the ring topology via the port to a corresponding direction. For instance, the main node 601 may transmit the ranging packet with the time stamp in the first direction corresponding to the clockwise direction and the second direction corresponding to the counterclockwise direction. The RT node 604 may measure the first delay based on the ranging packet delivered through the path in the first direction 603 and measure the second delay based on the ranging packet delivered through the path in the second direction 602. In addition, the delay compensation may be performed based on the difference value DD between the first delay and the second delay. For instance, the larger delay value between the first and second delays may be set as the reference delay, and the delay compensation may be performed for the delay to be equal to the reference delay.

Referring to 620, when one direction of the two directions is set to an initial data transmission direction and the other direction of the two directions is set to a backup direction, a main node 621 may block an port 622 to the backup direction and the each RT perform the delay compensation, accordingly. As an example, in a case that the first direction corresponding to the counterclockwise direction is set to the data transmission direction of the downlink and the second direction corresponding to the clockwise direction is set to the backup direction, the main node 621 may block the port 622 connected to the node F lest data should be transmitted in the second direction in the ring topology and thus data are delivered in the first direction 623.

FIG. 7 is a schematic diagram showing a network with a ring topology in which a switching occurs according to an exemplary embodiment of the present inventive concept.

Referring to 710 of FIG. 7, a line failure may occur between a node C 711 and a node D 712 among nodes in the middle of transmission in the fronthaul network with the ring topology.

Referring to 720, the node C 721 and the node 722 adjacent to failure line may block the ports to the failure line and broadcast a signal failure message.

Referring to 710 and 730, as receiving the signal failure message, a main node A 731 may unblock the blocked port 714 in the clockwise direction 732 and continue to transmit data transmission, which is a switching process. In addition, the main node A 731 may transmit ranging packets via unblocked ports to both directions in order for each node to perform the compensation after switching. Each node may compare the delays before switching and after switching and compensate for the delay by adjusting the buffer size.

Referring to 740, a main node A may transmit the ranging packets and data packets via unblocked ports not only to the clockwise direction but also to the counterclockwise direction so that packets are delivered to the nodes in the clockwise direction, such as to a node D 743. In this case, the data transmission from the main node A 741 may be performed in both the counterclockwise direction and the clockwise direction until the line between a node C 744 and the node D 743 is recovered, and after recovery the data may be transmitted again in one direction by the main node A 741 blocking one ports and the node C 744 and D 743 unblocking the blocked ports.

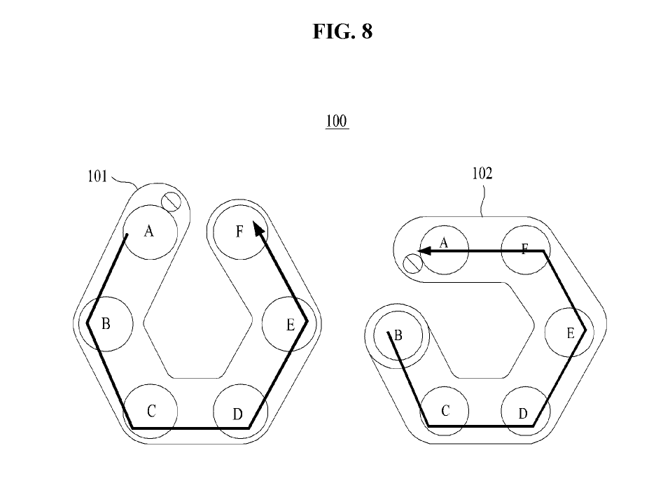

FIG. 8 is a schematic diagram showing an embodiment in which the ranging operation is implemented.

According to protocols regarding a layer-2 (L2) bridge, a certain port on a loop generated along the transmission line must be disabled (blocked) to prevent a loop generation in a network. This protocol prevent the way to measure the transmission delay in both directions, that is, the first direction and the second direction in the ring topology. To solve this problem, the L2 bridge protocol is required to be altered by modifying an access control list (ACL) in the use of unicast packets. In another way, the ranging operation may be performed by a multiple instance ring technology. The multiple instance ring is a ring topology network in which a L2 network is divided into a plurality of VLAN (virtual local area network) domains and the generated VLAN domains are controlled by using ERP (Ethernet Ring Protocol) ring instance. In this case, the blocking operation is not performed with respect to ports, but performed with respect to VLAN domains. Accordingly, a transmission direction may be determined according to the corresponding VLAN.

A ranging method and a ranging system based on the multiple instance ring are as follow.

First, nodes based on L2 switches in a ring topology are grouped into the multiple instance rings mapped to a plurality of VLAN domains (e.g., 100, 101, and 102). Each VLAN domain may consist of the same components or the same nodes configurated in a physical layer. The VLAN domain 101 blocks the main node A′s port in the second direction to measure the delay in the first direction, and the VLAN domain 102 blocks a port in the first direction to measure the delay in the second direction. The VLAN domain 100 may correspond to configuration for the data transmission.

In this case, the VLAN domains 101 and 102 may perform port blocking in a forced manner with a command of force switch lest the transmission direction should be switched even in the case of line failure and protection switching. After the compensation operation based on the ranging result, the normal data transmission is performed using the VLAN domain 100.

In this case, a port of each node performing ranging operation may have a static priority over other traffic in order to obtain the accurate transmission delay measurements, with less delay variation, not affected by traffic load.

In addition, the RT may periodically measure the delay in the first direction via the VLAN domains 101 and in the second direction via the VLAN domain 102 to keep calibrating the delay value.

In the case when the protection switching occurs due to a link failure, the VLAN domains 101 and 102 forcibly block the port by using a command of force switch, ignoring the signal failure signal, and thus may monitor continuously the operation in both directions.

The ranging operation may be performed by the multiple instance ring technology as described above.

The protection switching method and the system consisting of layer-2 switch-based nodes in a ring topology in a fronthaul network may perform the ranging operation to measure the transmission delays in the clockwise and the counterclockwise directions and may compensate for the difference in delay between in the two directions, thereby reduce the delay variation when the protection switching occurs. That is, a size of buffer is adjusted for the delay compensation to maintain the steady delay value after the protection switching. This method may achieve the stable transition with less variation in timing parameters from protection switching and improve the performance of time sensitive networks. This method for reducing the delay variation may be applied to various fields, e.g., telecommunication for disaster and relief, an E911 network, position estimation in mobile services, and other areas related to time sensitive network, etc.,.

The methods according to the embodiments of the present invention may be implemented in the form of program instructions that can be executed by various hardware or software, and may be stored in a computer readable recording medium. The computer readable recording medium may include program instructions, data files, data structures and the like separately or in combination. The program instructions stored in the computer readable recording medium may be specially designed and configured for the present invention, or may also be known and available to those skilled in the computer hardware and/or software field. Examples of the computer readable recoding medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like.

While this disclosure includes specific examples, it will be apparent to one of ordinary skill in the art that various changes in form and details may be made in these examples without departing from the spirit and scope of the claims and their equivalents. Suitable results may be achieved if the described techniques are performed in a different order, and/or if components in a described system, architecture, device, or circuit area combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A protection switching method in a time sensitive network with a ring topology comprising a plurality of switch-based nodes, comprising:
ranging to measure a first delay until a packet arrives at each node, RT, after transmitted by the main node OT via a path of a first direction and a second delay via a path of a second direction;
performing a transmission delay compensation in the first direction or in the second direction based on the first delay and the second delay;
transmitting the data in one direction out of the first direction and the second direction based on the delay compensation; and
performing a protection switching and compensating by performing the protection switching and compensation based on the measured delay after the switchover.

2. The protection switching method of claim 1, wherein the ranging comprises:
Unblocking a port to the first direction and a port to the second direction of the main node for ranging to measure the first delay and the second delay.

3. The protection switching method of claim 1, wherein the transmitting the data comprises:
blocking a port corresponding to the one direction out of the first direction and the second direction; and
normally transmitting the data via the unblocked port to the other direction.

4. The protection switching method of claim 1, wherein the performing the protection switching and compensating comprises:
broadcasting, by nodes adjacent to failure line, a signal failure packet;
unblocking the blocked port, by the main node, and transmitting the data and ranging messages to both of the two directions; and
performing, by each RT node, the compensation based on the delay measured after the switching.

5. The protection switching method of claim 1, wherein the performing the delay compensation comprises:
choosing the larger delay between the first delay and the second delay for a reference delay; and
compensating for a delay in data transmission in the first direction or in the second direction with respect to the reference delay.

6. The protection switching method of claim 5, wherein the compensating for the delay with respect to the reference delay comprises:
adjusting a size of a buffer with respect to the reference delay.

7. The protection switching method of claim 6, wherein the adjusting the size of the buffer comprises:
increasing, in a case that the data are transmitted in a direction producing the smaller delay between in the first direction and in the second direction, the size of the buffer by adding a value corresponding to a difference between the first delay and the second delay to a default buffer size in order to make the data transmission delay maintained equal to the reference delay.

8. The protection switching method of claim 6, wherein the adjusting the size of the buffer comprises:
maintaining the size of the buffer of a default value unchanged in a case that the data are transmitted in a direction producing the larger delay between in the first direction and in the second direction, and the delay compensation for data transmission is omitted.

9. The protection switching method of claim 4, wherein the performing, by the each RT node, the operation corresponding to compensating based on the measured delay after the switchover compensation comprises:
comparing a delay before the protection switching to a delay after the protection switching; and
increasing or decreasing the current size of a buffer by a value corresponding to a difference in delays between before and after switching based on the result of the comparing process in the case that the delay is changed due to the switching.

10. A protection switching system for one node among a plurality of switch-based nodes in a time sensitive network with a ring topology, comprising:
a ranging unit configured to measure a first delay until a packet arrives at each node, RT, after transmitted by the main node OT via a path of a first direction and a second delay via a path of a second;
a compensating unit configured to perform a transmission delay compensation in the first direction or in the second direction based on the first delay and the second delay;
a transmitting unit configured to transmit the data in one direction out of the first direction and the second direction based on the delay compensation; and
a protection switching/compensating unit configured to perform a protection switching and compensation based on the measured delay after the switchover.

11. The protection switching system of claim 10, wherein the ranging unit is configured to:
unblock a port to the first direction and a port to the second direction of the main node for ranging to measure the first delay and the second delay.

12. The protection switching system of claim 10, wherein the transmitting unit is configured to:
block a port corresponding to the one direction out of the first direction and the second direction; and
normally transmit the data via the unblocked port to the other direction.

13. The protection switching system of claim 10, wherein the protection switching/compensating unit is configured to:
broadcast, by nodes adjacent to failure line, a signal failure;
unblock the blocked port, by the main node, and transmitting data and ranging message to ports in both of the two directions; and
perform, by each RT node, compensating based on the measured delay after the switching.

14. The protection switching system of claim 10, wherein the compensating unit is configured to:
choose the larger delay between the first delay and the second delay for a reference delay; and
compensate for a delay in data transmission in the first direction or in the second direction with respect to the reference delay.

15. The protection switching system of claim 14, wherein the compensation for the delay with respect to the reference delay is performed by adjusting a size of a buffer with respect to the reference delay.

16. The protection switching system of claim 15, wherein the adjusting of the size of the buffer with respect to the reference delay is performed by increasing, in a case that the data are transmitted in a direction producing the smaller delay between in the first direction and in the second direction, the size of the buffer by adding a value corresponding to a difference between the first delay and the second delay to a default buffer size to make the data transmission delay maintained equal to the reference delay.

17. The protection switching system of claim 15, wherein the adjusting of the size of the buffer is performed by maintaining the size of the buffer of a default value unchanged in a case that the data are transmitted in a direction producing the larger delay between in the first direction and in the second direction, and the delay compensation for data transmission is omitted.

18. The protection switching system of claim 13, wherein the performing, by the each RT node, of the operation corresponding to the compensating is performed by:
comparing a delay before the protection switching to a delay after the protection switching; and
increasing or decreasing the current size of a buffer by a value corresponding to a difference in delays between before and after switching based on the result of the comparing process in the case that the delay is changed due to the switching.
